(19) United States
(12) Patent Application Publication
(10) Pub. No.: US 2004/0142062 A1
(43) Pub. Date: Jul. 22, 2004

(54) Dough stripping assembly for dough sheeting machines

(76) Inventor: Michael Herrera, Los Alamitos, CA (US)

Correspondence Address: MYERS DAWES & ANDRAS, 19900 MacArthur Blvd., Suite 1150, Irvine, CA, 92612, US

(21) Appl. No.: 10/346,362

(22) Filed: Jan. 17, 2003

(51) Int. Cl. A21C 11/10

(52) U.S. Cl. 425/298; 425/363

(57) ABSTRACT

In a dough stripping assembly and method, stripping elements are supported in relatively spaced relation on the sheeting machine with an edge of the crosspieces parallel to and abutting an outer surface of the roller. As the roller turns, the stripping element scrapes shaped dough from the roller and leaves a remaining web of dough adhered to the roller. With many cut patterns, the crosspiece separates a portion of the web from the roller as well. However, the portion of the web that remains adhered to the roller pulls the separated portion of the web along with the adhered portion. Thus, the separated portion of the web is permitted to move past the stripping elements and continues to move with the outer surface of the roller and is returned with the rest of the web to a point upstream of the sheet forming pinch point.

### BACKGROUND OF THE INVENTION

1. Field of the Invention

The instant invention lies in the field of dough sheeting machines for making tortillas and the like. Specifically, the instant invention addresses removing sheeted dough from rollers. Of particular interest in this field is the ability to selectively remove a portion of sheeted dough from a roller while leaving another portion of the sheeted dough adhered to the roller for reentry into a mass of dough upstream of a pinch point for reprocessing and re-sheeting of the dough. A variety of means for doing this have been employed in the prior art.

2. Disclosure of the Prior Art

The prior art has many sheeting machines with a variety of ways of removing sheeted dough from rollers. However, the prior art is deficient in that it does not apply scrapers on front rollers of Tortilla machines. The prior art is also deficient in that it fails to show how such scrapers remove a shaped dough and permit return rework for entry into a mass of dough for re-entry into the sheeting process. In particular, the prior art is deficient in showing how to properly position a bladelike scraper with respect to a front roller in order to balance the forces of gravity and inertia so that shaped dough is removed while rework remains adhered to the roller.

It is also known in the prior art to separate a portion of the sheeted dough from a shaped dough that has been cut into the sheeted dough by pulling the portion of the sheeted dough along with the surface of a roller by means of the portion of the sheeted dough itself. The shaped dough separates from the roller since there is no continuous dough pulling the shaped dough along. However, the prior art is deficient in providing this type of separating of shaped dough with a blade-type scraper.

In one prior art embodiment, excess dough is pulled along with the moving surface of the front roller and is returned to a mass of dough upstream of the pinch point. To accomplish this, there is a roller having a groove that enhances the sticking of the dough to the roller. In the groove of this embodiment, there is a brass strap to which dough adheres more readily than it does to a surface of the roller. The strap fits somewhat loosely in the groove, and there is a wire stretched across the width of the roller with the wire disposed between the roller and the brass strap. The brass strap is flexible and is moved outwardly of the groove at a point where the wire is disposed between the roller and the strap. Hence, as the roller turns, the brass strap is continuously being lifted from the groove at a point corresponding to where the wire is stretched. In this way, the wire serves the purpose of separating sheeted dough from the roller along most of the surface of the roller. However, the dough that is adhered to the brass strap is not separated from the brass strap by the wire since the wire does not pass between the brass strap and the dough. Hence, the dough remains adhered to the brass strap and roller combination by means of the dough being adhered to the brass strap at a position of the groove on the roller.

In this way, rework or web material, (a web of the dough that is to be returned upstream of the pinch point), is carried along with the strap, and hence with the roller, while a main or shaped portion of the sheeted dough is separated from the roller by means of the stripper wire. This is a predominant prior art method that has been used for selectively removing sheeted dough while adhering a portion of the sheeted dough known as the “web” or “rework”.

Crosspiece

The drawbacks of the prior art in the case of the wire and brass strap approach are that the wire often breaks and needs to be restrung in order to continue to remove the sheeted dough from the roller. Furthermore, wires of this prior art device also need frequent adjustment to maintain the needed tension. Also, the straps that are positioned in the grooves, (which may be formed of brass, stainless steel, or plastic), can also break or come off. When this happens, the rework is separated from the roller at the groove as well as the shaped dough. Downtime for adjusting or replacing wire or straps causes much loss of time and reduces overall output of food products by the machine.

There is a need in the art to provide a new and improved manner and means for removing sheeted dough from a roller of a sheeting machine.

There is a need for the new method and means for removing sheeted dough to be reliable. That is, the new method and means should obviate the need of frequently replacing parts and making adjustments. There is also a need for providing a means and method of removing dough that does not require a roller having grooves at pre-selected positions along the length of the surface of the roller.

The prior art is deficient in providing gaps at locations along the roller corresponding to the portions of the sheeted dough that are to be returned to the mass of dough upstream of the pinch point. In particular, the prior art is deficient in providing a relatively broad crosspiece(s) supported near or on the surface of a front roller by a spacing member.

There is also a need for an adjustable apparatus for removing or stripping dough from a front roller of a sheeting machine, wherein the widths of the sheeted dough being removed may be adjusted. Likewise, the width of web or rework needs to be adjustable by way of this apparatus. In this way, a single roller might be utilized with a variety of die rollers and the adjustable dough stripping apparatus. For a specific die roller, the apparatus may be supplied with a plurality of stripping elements of specific widths, placed at specific positions, and having gaps between the stripping elements to provide an opening through which the rework might pass and remain adhered to the roller.

It is also important that the new apparatus be fairly adjustable and retrofittable on a variety of machines, and the mounting means for of the apparatus must be stable and reliable.

There is a need for this new apparatus to be an assembly in which one or more of the stripping elements may be selectively provided.

There is a need for a stripping element or scraping apparatus for removing sheeted dough from a roller that has a broad crosspiece for removing a pre-selected width of sheeted dough while permitting a portion of the dough to remain adhered to the roller. Furthermore, there is a need to provide a means for permitting a first portion of the adhered dough to move over the broad crosspiece as a second portion of the adhered dough pulls the first portion of the adhered dough along, in motion with the surface of the roller.

### SUMMARY OF THE INVENTION

The dough stripping assembly for a dough sheeting machine of the present invention overcomes the deficiencies of the prior art and fills the needs set forth above. The assembly forms an apparatus on a sheeting machine for stripping shaped dough from a front roller after a pattern has been cut in a sheet of dough in the machine. In one embodiment, the apparatus advantageously leaves a web of dough on the front roller for reworking. The invention generally implements a doctor blade type scraper or stripping element. That is, the stripping element is a relatively stiff or rigid member with an edge that matches the contour of the roller to be scraped. Typically, that contour is linear in a direction parallel to an axis of rotation of the roller.

In one version of this embodiment, the assembly comprises at least one stripper or stripping element having a crosspiece with an edge adapted for parallel alignment with a front roller on which dough regularly sticks. In this version, the stripping element also has at least one spacer leg supporting the crosspiece and extending transversely from the crosspiece. To support the crosspiece and spacer leg, the assembly has at least one mounting bar supporting the spacer leg and extending transversely to the spacer leg. The mounting bar is adapted to be mounted to the dough sheeting machine to support the at least one spacer leg and the crosspiece in a position with the crosspiece substantially abutting the front roller to scrape shaped dough from the front roller and leave the rework at least partially adhered to the front roller. This version of this embodiment is particularly advantageous in use on tortilla makers since they typically have a relatively large amount of rework.

In another version of this embodiment, the stripping element can be a single generally rectangular flat piece supported on the mounting bar. In this version of this embodiment, the rectangular flat piece can be one of a plurality of flat pieces. In the version having a plurality of flat pieces, the pieces may be positioned in spaced relation to each other to leave gaps. Alternatively, a still further embodiment is provided by placing the rectangular flat pieces in abutting relation having no gaps.

In all of the embodiments, the shaped dough is removed for further processing while the rework selectively moves with an outer surface of the front roller and is returned and joined to a mass of dough upstream of a pinch point to be re-entered in a sheeting step.

The crosspiece described above may be single crosspiece or one of a plurality of crosspieces. The spacer leg may likewise be a single spacer leg or one of a plurality of spacer legs. Each of the crosspieces is supported by at least one of the of the spacer legs, and the mounting bar supports the spacer legs.

In one embodiment, the plurality of spacer legs are supported on the mounting bar in spaced relation to each other and supports the crosspieces in spaced relation such that there is at least one gap between longitudinal ends of adjacent ones of the crosspieces. The number of crosspieces and their spacing may be adjusted such that there is only one gap or such that there is a plurality of gaps formed between adjacent ones of plurality of crosspieces.

The spacer legs may be removably supported on the mounting bar. The crosspieces may be removably supported on the spacer legs. The assembly further has at least one bracket and at least one fastener for attaching the mounting bar to the dough sheeting machine. The assembly also has at least one adjustment means for adjustably positioning the mounting bar on the dough sheeting machine. The means for adjustment may be in the form of a threaded shaft of any kind. Preferably, the threaded shaft will have a winged head or some other structure of grasping and turning the shaft. Several other alternatives may be substituted for the threaded shaft including but not limited to pins and holes, detent type fasteners, and pawl and tooth mechanisms including ratcheting mechanisms. Additionally, at least one support means for supporting the crosspieces on the dough sheeting machine may be provided in order to selectively adjust the amount of pressure with which the stripping element contacts the roller.

Alternatively, the crosspieces can be integrally formed with the spacer legs to provide one piece stripping elements. Furthermore, a plurality of stripping elements can be integrally connected to form a single multi-element stripping member. For example, the respective stripping elements can be integrally connected by a common joining bar, wherein the stripping elements, the spacer legs, and the joining bar are formed of one piece. In this case, the stripping elements can be mounted on the dough sheeting machine by mounting the joining bar to the mounting bar. Alternatively, the joining bar can function as the mounting bar.

While the assembly of the instant invention may be formed of a variety of materials including steel, the stripping member is preferably formed of an ultra high molecular weight material (HMWM). HMWM plastics have the advantage cleaning up well before and after use. HMWMs also have the structural rigidity, strength and durability needed for the forces and abrasion applied in the scraping operation. Furthermore, HMWMs are readily machinable and can therefore be shaped to the needed configurations of the instant invention.

The invention is also characterized as the combination of a dough sheeting machine having a dough stripping assembly for removing a shaped dough and leaving a web of dough for re-entry into a mass of dough upstream of a pinch point. In this case, the sheeting machine comprises at least one front roller to which dough generally sticks after being sheeted and cut. The sheeting and cutting produces the shaped dough for additional processing into food products and the web for return and re-entry in the sheeting and cutting process.

The combination sheeting machine and dough stripping assembly may have at least one spacer leg supported on the sheeting machine and extending lengthwise transversely to an axis of rotation of the front roller in accordance with at least one of the embodiments set forth above. This combination also has at least one crosspiece supported on the spacer leg with a length of said crosspiece extending generally transversely to the spacer leg. The crosspiece extends generally parallel to the axis of rotation as well as to a surface of the front roller. The crosspiece has a straight edge extending along the length and substantially abutting the front roller for stripping the shaped dough from the front roller while leaving the web at least partially adhered to the front roller for return to the mass of dough upstream of the pinch point.

In the combination dough sheeting machine and stripping assembly, the spacer leg and the crosspiece generally form a T-shape, a die roller is provided for cutting a predetermined pattern into the sheeted dough, and the at least one crosspiece has a width generally equal to a width of the predetermined pattern and the shaped dough such that the at least one crosspiece separates the shaped dough from the front roller while leaving at least a portion of the web adhered to the front roller.

In one aspect of the invention, the at least one spacer leg is one of a plurality of spacer legs, and the at least one crosspiece is one of a plurality of crosspieces. The plurality of crosspieces have gaps between longitudinal ends of adjacent ones of the crosspieces. The distance between the longitudinal ends is generally equal to a distance between adjacent rows of the shaped dough such that a portion of the web between the shaped dough is left adhered to the front roller after scraping by the crosspieces.

It is to be explicitly understood that the combination may include any of the embodiments of the dough stripping assembly. Specifically, the stripping element can comprise a generally rectangular piece. Furthermore, a plurality of the rectangular stripping elements can be connected to a common joining bar. In this case, the rectangular stripping elements and joining bar are integrally formed into a single stripping member for attachment to the mounting bar. Alternatively, the plurality of stripping elements can be separate from each other and can be separately, removably and adjustably mounted to the mounting bar.

The straight edge abuts the front roller at a position on an outer surface of the front roller generally corresponding to three o'clock when viewed along an axis of rotation with the front roller rotating in a counter-clockwise direction.

It is to be expressly understood that in the simplest form of the instant invention the stripping element may be of any of the number of shapes as long as it has an edge adapted for parallel alignment with a front roller on which dough regularly sticks. The mounting bar may also have any of a variety of configurations so long as the mounting bar supports the stripping element. The mounting bar is mounted to the dough sheeting machine to support the stripping element in substantially abutting position relative to said front roller to scrape shaped dough from the front roller and leave the rework at least partially adhered to the front roller so that the shaped dough is removed for further processing while said rework moves with an outer surface of the front roller and is returned and joined to a mass of dough upstream of a pinch point to be re-entered in a sheeting step.

A method of removing shaped dough from a front roller of a dough sheeting machine is achieved by the stripping assembly of the instant invention. In one embodiment, the stripping assembly has a stripping element with at least one crosspiece and a spacer leg supporting the crosspiece and mounted to a mounting bar as set forth above. The method comprises the steps of: positioning the stripping element in abutting scraping relation to the front roller, separating the shaped dough from the front roller by the stripping element, and leaving a web of dough adhered to unscraped portions of the front roller.

The method of the instant invention may be accomplished with a stripping member having a plurality of stripping elements. The shaped dough may comprise a plurality of rows of shaped dough. In this case, the step of separating further includes spacing the plurality of stripping elements from each other such that a gap is provided between respective crosspieces of adjacent ones of the stripping elements. The step of leaving includes, leaving a web of minimum width between adjacent ones of the plurality of rows. The method further includes providing a crosspiece with a width generally equal to a maximum width of the shaped dough. Another important step of this method is positioning the plurality of stripping elements in alignment with the plurality of rows such that the gaps are correlated with the minimum width of the web so that a portion of the web remains unscraped during the step of separating.

In one aspect of the invention, the step of leaving further comprises separating a first portion of the web of dough from the front roller by the crosspiece of the stripping element and permitting the first portion of a web to pass over the crosspiece, while a second portion of the web remains adhered to the front roller. In this case, the first portion of the web is carried by the adhered second portion on the front roller back to a mass of dough upstream of a pinch point to be re-entered in a sheeting and a cutting step.

As set forth above in the summary of the apparatus, the method likewise does not require a specifically shaped stripping element so long as it presents an edge that substantially abuts the front roller in a scraping action.

### BRIEF DESCRIPTION OF THE DRAWINGS

FIG. 1 is a perspective view of the stripping assembly mounted to a dough sheeting machine.

FIG. 2 is an exploded view of the stripping assembly of the instant invention.

FIG. 3 is a perspective view of a dough sheeting machine together with stripping assembly of the instant invention.

FIG. 4A is a diagrammatic end view of a front roller, back roller and cutter roller showing the sheeting, cutting, and stripping steps of the method.

FIG. 4B is a perspective view of the stripping element of FIG. 4A.

FIG. 5 is a perspective view of a front roller and a stripping member stripping sheeted tortilla chips from a roller.

FIG. 6A is a plane view of one embodiment of a stripping member.

FIG. 6B is a plane view of an additional embodiment of the stripping member.

FIG. 6C is a plane view of a further embodiment of the stripping member.

FIG. 7A is a perspective view of an additional embodiment of a stripping element.

FIGS. 7B and 7C are perspective views of a further additional embodiment of a stripping element.

FIG. 7D is a perspective view of a still further additional embodiment of a stripping element.

FIG. 7E is a section view taken along lines VIIE-VIIE of FIG. 7D.

FIG. 7F is a diagrammatic view of a stripping assembly having air lines and a vibration means connected to the stripping members.

FIG. 7G is an exemplary diagrammatic end view similar to FIG. 4 depicting the stripping member of FIGS. 7D and 7E having pressurized air and the vibration means connected to the stripping member.

FIG. 8A is a perspective view of the prior art groove and brass strap embodiment.

FIG. 8B is an end view of the prior art embodiment of FIG. 8A.

### DETAILED DESCRIPTION OF THE PREFERRED EMBODIMENTS

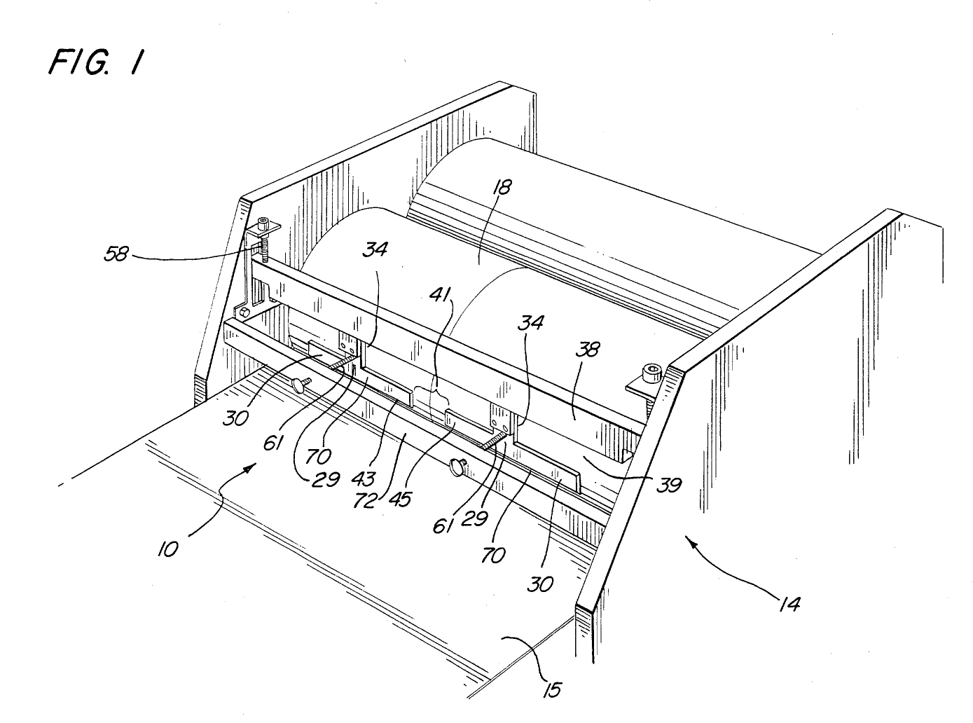

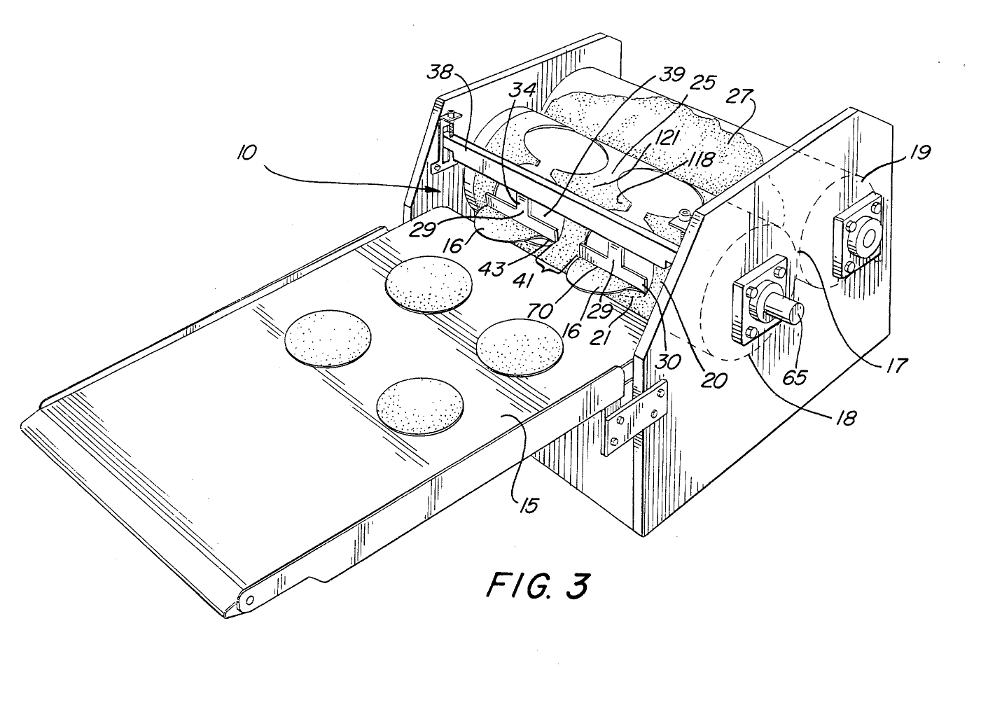

FIGS. 1 and 3 show the dough stripping assembly 10 mounted on a dough sheeting machine 14. The dough sheeting machine 14 sheets and shapes the dough in a conventional manner for placement on a conveyor belt 15. The shaped dough 16 is shown in FIG. 3. To provide the shaped dough 16, there is a pinch point 17 at a position where the front roller 18 is closest to a back roller 19. In use, turning movement of the front roller 18 and the back roller 19 rolls the dough and a sheet of dough is formed at pinch point 17. The resulting sheeted dough 20 is then cut with a pattern 21. A portion of the pattern that is not intended to be further immediately processed as a food product is called the “web” or “rework” 25. The web or rework 25 is recycled or returned and reentered into a mass of dough 27 which is to be processed and sheeted in the aforementioned process of sheeting and cutting.

FIGS. 1-3 show a stripping element 29 having a crosspiece 30 supported by a spacer leg 34. The spacer leg 34 is supported on a mounting bar 38. The mounting bar 38 and spacer leg 34 support the crosspiece 30 in abutting relation to the outer surface 39 of the front roller.

As shown in FIG. 1, at least one gap 41 is provided between longitudinal ends 43 and 45 of adjacent crosspieces 30.

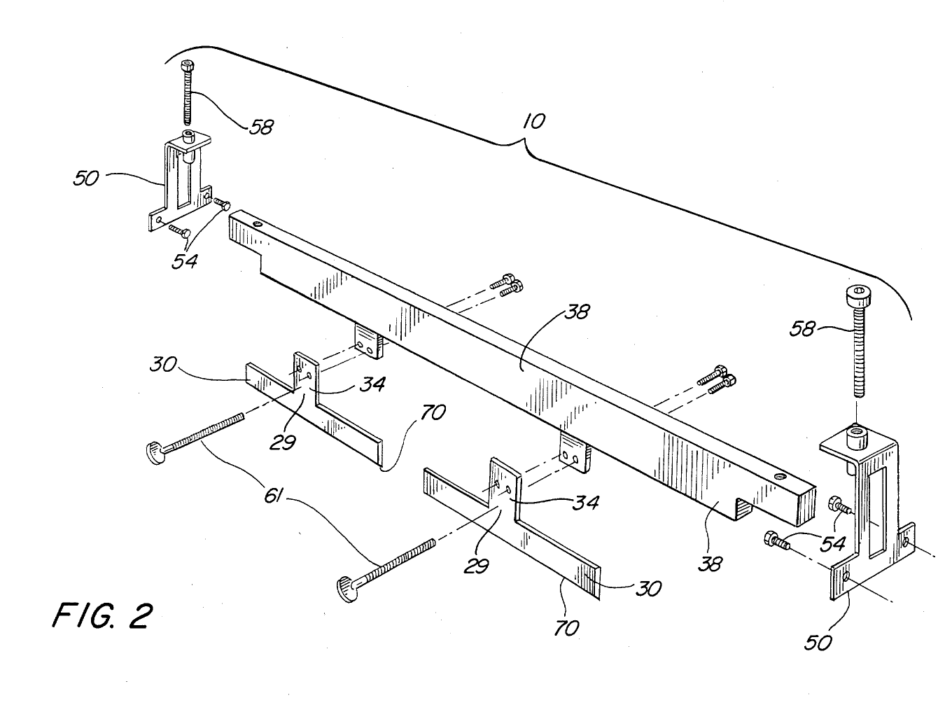

FIG. 2 shows a perspective exploded view of the dough stripping assembly 10 shown in FIG. 1. The dough stripping assembly 10 includes a brackets 50. A plurality of fasteners 54 for mounting the brackets 50 on the dough sheeting machine 14. Brackets 50 include adjustment means 58 for positioning the mounting bar 38 and the crosspieces 30 supported therefrom with respect to the front roller 18. As can be appreciated from FIGS. 1 and 3, the adjustment means 58 can be used to adjust a height position of the dough stripping assembly 10 with respect to the front roller 18.

As can be appreciated from FIG. 3, the front roller 18 has an axis of rotation 65. The crosspiece 30 has a straight edge 70, which is positioned adjacent and parallel to, if not abutting, the outer surface 39 of the front roller 18. FIGS. 1 and 2 have support means 61 in the form of screws with heads that enable manual adjustment. These screws 61 are threadedly connected to a structural member 72 of the sheeting machine 14 and are positioned to abut the stripping elements 29 for adjustably applying a force on the stripping members in a direction towards the front roller 18. Thus, adjustment means 58 and support means provide adjustment of the stripping elements in height and fore and aft directions. Support means 61 can also provide a continuous force by the stripping elements on the surface 39 of the front roller 18. It is to be understood that the support means 61 may include other adjustment devices including wedge member(s), cam mechanisms, over-center mechanisms, levers, and/or hydraulic or pneumatic devices.

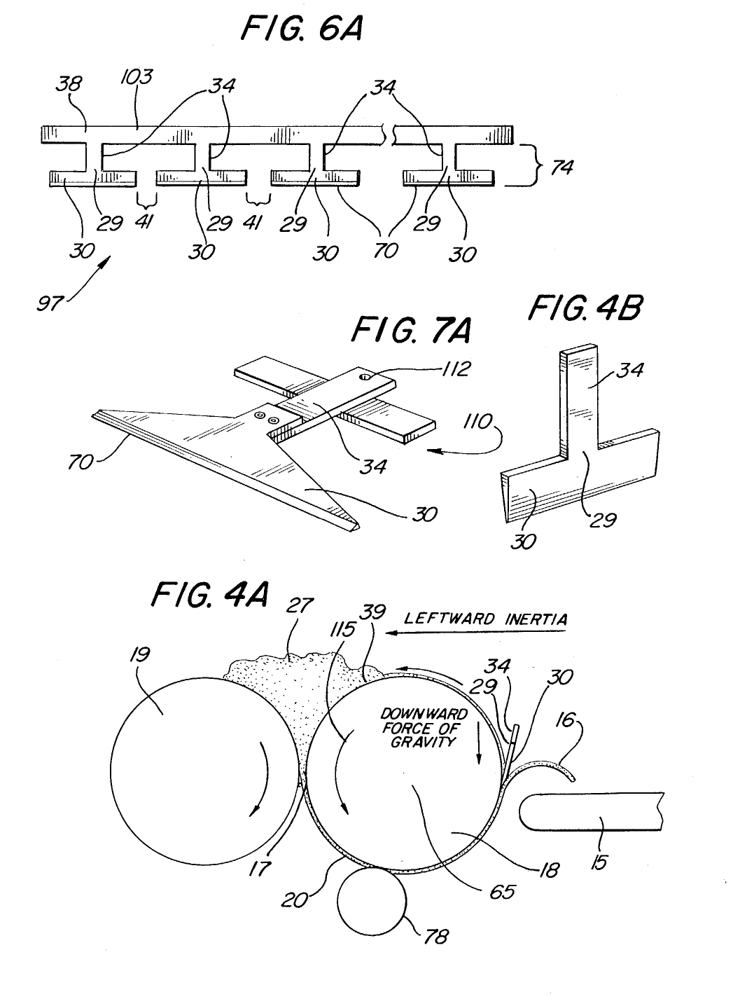

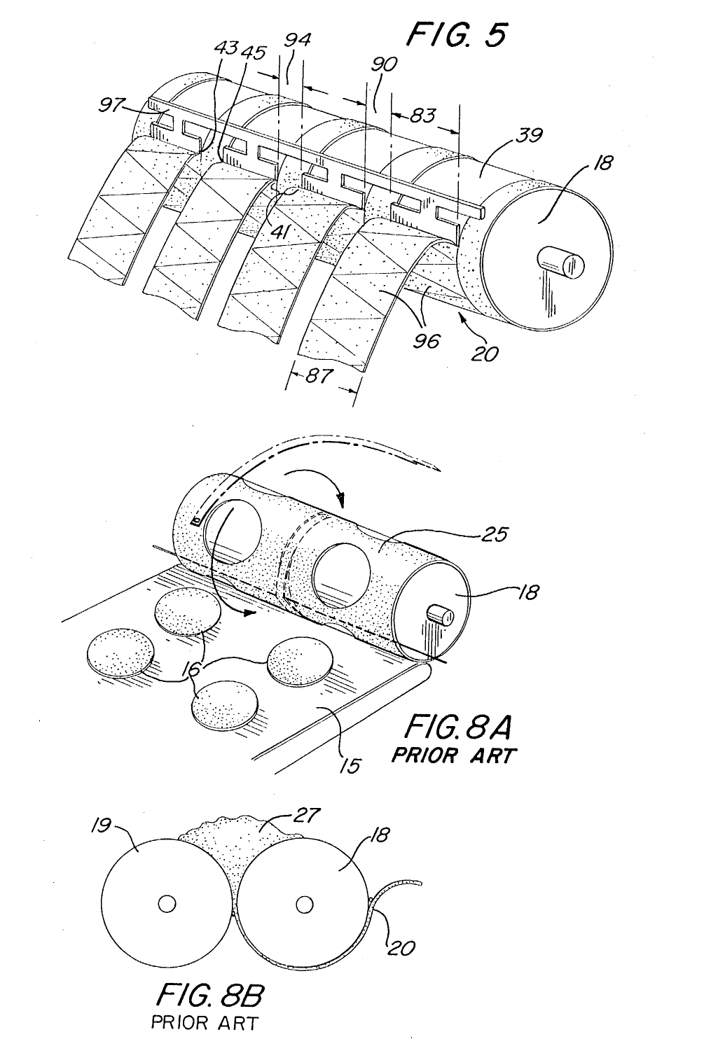

FIG. 4A shows a die roller or cutter roller 78. This die roller 78 is a conventional roller for shaping sheeted dough 20. The die roller 78 conventionally shapes the dough in rows along the length of the front roller 18. As perhaps best illustrated in FIG. 5, a width 83 of the crosspiece is selected to match the width 87 of the shape or pattern 96 cut by the guide roller 78.

Returning to FIG. 4A, it can be seen that a number of forces act on the sheeted dough 20. Firstly, the front roller 18 is rotating counterclockwise at a substantially constant rate and provides inertia to the sheeted dough 20 that is adhered thereto. Secondly, stripping element 29 applies a force to the dough 16, 20 during scraping. Thirdly, gravity becomes a significant force on the dough that has been separated from the front roller 18.

Taking these forces and the consistency of a given dough into account helps an operator determine the proper position at which the stripping element 29 should abut the front roller 18. For example, for more fragile doughs, a position in the maximum range from 2:30 to 6:00 o'clock may be selected. On the other hand, for more sticky doughs, a position in the range from 2:00 to 7:00 o'clock may be selected. However, in most cases the position at which the stripping elements 29 should abut the front roller 18 is in the range from about 3:00 to 4:00 o'clock on the front roller as viewed in FIG. 4A.

The stripping element 29 is shown in perhaps its simplest form in FIG. 4B. In this perspective view, it can be seen that the stripping member can be formed of a single piece having a spacer leg 34 and a crosspiece 30 having a T-shape 74. This T-shaped stripping element can be incorporated in the embodiments of FIGS. 1-5.

FIG. 5 is a perspective view showing the removal or separation of a portion of sheeted dough 20 from a cut pattern 96 of sheeted dough that is cut in a pattern for tortilla chips. FIG. 5 is particularly useful in showing the respective widths of the crosspiece and the rows of patterned dough of the dough sheets. For example, the distance 90 between longitudinal ends 43 and 45 of the crosspieces is shown in relation to the distance 94 between rows of shaped dough 96.

As can be appreciated from the variation of cut pattern 96 shown in FIG. 5. The instant invention provides the possibility of having any of the variety of cut patterns on sheeted dough while using a single given front roller. The configuration of the dough stripping assembly 10 is determined by the pattern of shaped dough that is selected.

To this end, the dough stripping assembly may advantageously be made adjustable so that the crosspieces 30 may be set at pre-selected distances from each other. As such, the gap 41 may be selectively provided between longitudinal ends 43 and 45 of adjacent crosspieces 30. The gap 41 defines a distance 90 between adjacent longitudinal ends 43, 45. This distance 90 is pre-selected to correspond to a distance 94 between the rows of shaped dough 96.

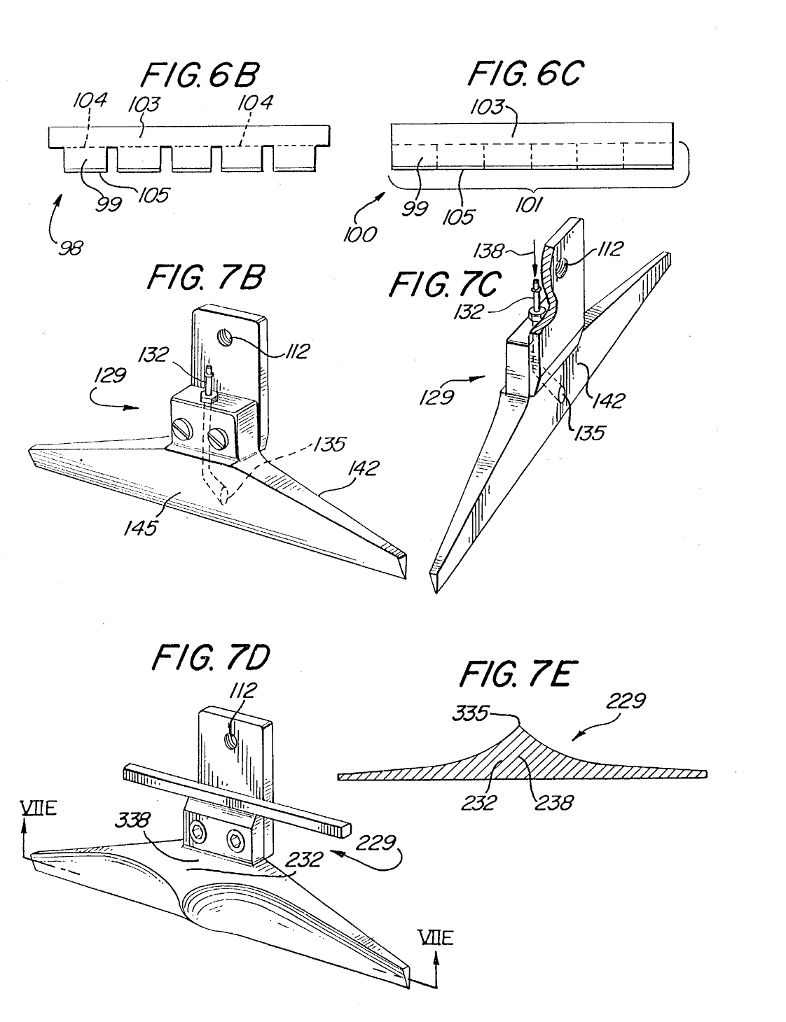

FIG. 6A shows a plane view of the stripping member 97 of FIG. 5. As can be appreciated from FIGS. 5 and 6A, the stripping member 97 may be configured to have a plurality of the stripping elements 29 joined together by a joining bar 103. To accomplish this, the stripping elements and the joining bar 103 can be formed as one piece.

FIG. 6B shows an additional embodiment 98 of the stripping member having stripping elements 99. As shown, the stripping elements 99 of this embodiment are generally rectangular and have gaps therebetween. Dashed lines 104 between the stripping elements 99 and the rest of the stripping member 98 indicate that the stripping elements 99 can be formed integrally or separately with the joining bar 103.

FIG. 6C shows a further embodiment 100 of the stripping member. In this embodiment, either a one piece stripping element 101 can be integrally formed with the rest of the stripping member 100 or may be attached thereto. Alternatively, a plurality of smaller stripping elements 99 may be provided. In this case, the stripping member 100 of this embodiment does not have any gaps between the plurality of stripping elements 99.

In all of the embodiments, the stripping elements 29, 99, 101 provide a straight edge 70, 105 for engaging and scraping the front roller of the dough sheeting machine 14. While shapes other than those shown and described may be implemented for the stripping elements of the instant invention, the shapes shown and described have certain advantages. For example, the T-shape 74 of stripping element 29 enables easy passage of a portion of the web over crosspiece 30. The rectangular stripping elements 99 and 101 have the advantage of being easy to manufacture and structurally stronger than the T-shaped stripping element 29. Of course, each of the embodiments having spaced stripping elements provide the advantage of permitting rework to pass by the stripping elements without being removed from the front roller.

It is of particular interest, and should be noted, that the stripping member 98 of FIG. 6B may be advantageously applied to the stripping operation shown in FIG. 5 without any loss of functionality. FIG. 5 depicts the making of tortilla chips and clearly shows that such a pattern requires relatively little or no rework within a specific maximum width of the pattern of the shaped dough 96. Hence, little or none of the rework is separated from the front roller 18. Further taking advantage of this pattern of shaped dough 96, it can be seen that the rows of shaped dough could be placed immediately next to each other. In shaped doughs of this type that require no rework between rows, the stripping member of FIG. 6C can advantageously be implemented since it has no gaps.

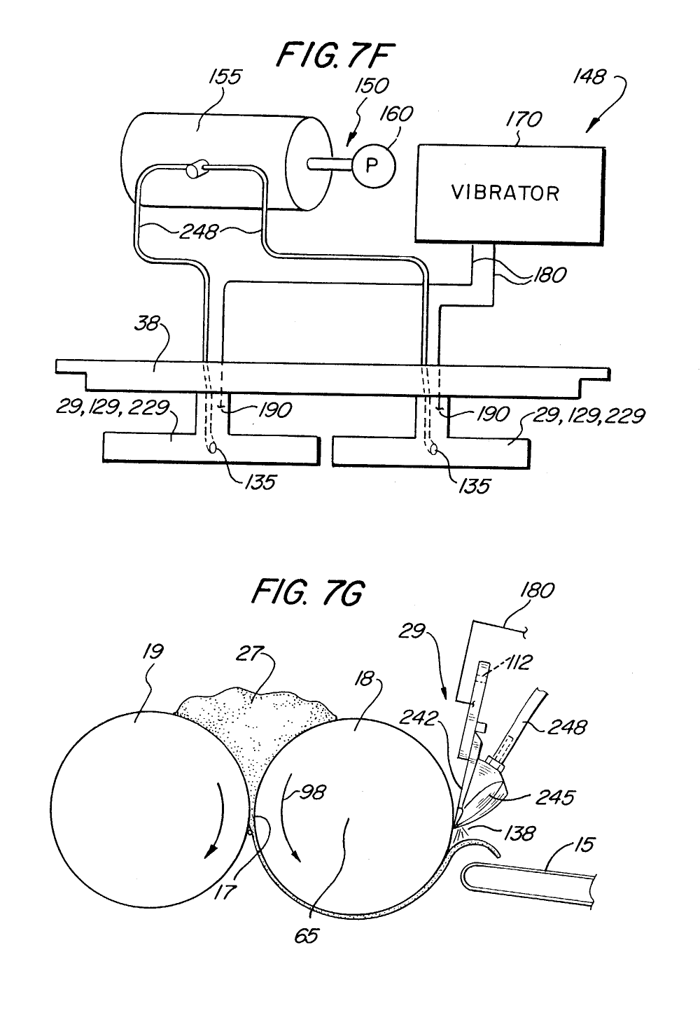

FIG. 7A is a perspective view of a stripping element 110 similar to the stripping element 29 described above, but having a slightly different configuration. As indicated by the means for fastening 112 shown in FIG. 7A, the stripping element 110 may be removable and adjustable with respect to the rest of the stripping assembly 10. Additionally, each crosspiece 30 and spacer leg 34 is replaceable in this embodiment. As can also be appreciated, the tapered ends of the crosspiece 30 of this embodiment advantageously permit even less impeded movement of rework over the crosspiece 30 than in the block T-shaped embodiment 29 of the stripping element.

FIGS. 7B and 7C illustrate an alternative embodiment of a stripping element 129 similar to stripping elements 29, 110, but having a pressurized air input means 132 connected to a nozzle 135 for aiding in dough removal during scraping. As can be appreciated, pressurized air 138 travels through the stripping element 129 and impinges on a surface of the front roller 18 as best shown in FIG. 7G. The air stream 138 is directed at any of a variety of angles to help with de-adhesion of the shaped dough 16 and/or portions of the rework 25 that need to be separated from the front roller 18. The air stream 138 can be selectively provided as a narrow stream or a broader flow in accordance with the needs of a particular application. Furthermore, the air stream 138 can be directed through a back side 142 of the stripping element 129 as shown in FIGS. 7B and 7C, or can be directed through a front side 145. It is to be understood that while air is the preferred pressurized gas for directing through the nozzle, any other gas could be used instead.

FIGS. 7D and 7E illustrate another alternative embodiment of a stripping element 229 similar to the stripping elements 29, 110, and 129 described above. The stripping element 229 has a whale tail configuration with structure that specifically aids in scraping as well as permitting portions of the rework to easily pass over portions of the stripping element 229. For example, built-up portion 232 forces dough generally away from a central portion 238 of the stripping element. This embodiment further has a dorsal fin 235 formed substantially as an extension of the built-up portion 232. The dorsal fin 235 advantageously forces the shaped dough 16 away from the central portion 238 and away from the front roller. Additionally, the dorsal fin 235 may help guide a portion 118 of the rework 25 as it passes over the stripping element 229 as can be appreciated from a view of FIG. 3. FIG. 7E is a sectional view taken along lines VIIE-VIIE of FIG. 7D, and illustrates the increasing thickness of the stripping element towards its central portion 238. This embodiment optionally has at least one airline 248 for delivering pressurized air to aid in separating the dough from the roller 18 as shown and further described with respect to FIGS. 7F and 7G below.

In still further alternative embodiments depicted in FIGS. 7F and 7G, the stripping elements 29, 99, 110, 129, and 229 can have a vibration means 148 connected thereto. The vibration means 148 can include any of a variety of vibrators 170 including an ultrasonic vibrator, a magnetic vibrator, a mechanical vibrator, or an electro-mechanical vibrator. The vibration means 148 adds further advantages to the instant invention including improved sheetability and de-adhesion. By applying vibrations to the stripping elements 29, 99, 110, 129, and 229, the peeling capability of the stripping element 129 is improved. It is to be explicitly understood that vibration means 148 can be implemented with any of the embodiments of stripping elements and stripping assemblies of this invention. Likewise, pressurized air 138 directed through nozzles 135 as described with respect to FIGS. 7B and 7C can be incorporated with any of the embodiments set forth above. As such, FIG. 7F is a schematic view showing both pressurized air and a vibration means connected to a plurality of stripping elements of the invention. It is to be understood that one or the other, or both of pressurized air and a vibration means can be applied to any of the embodiments of the invention. For example, FIG. 7G is an exemplary end view showing the stripping element 229 of FIGS. 7D and 7E incorporating the pressurized air and the vibration means 148.

With regard to FIG. 7F, the compressed air 138 can be provided by a conventional compressor 150 including a compressed air reservoir 155 and a pump 160. Lines 248 connect the reservoir to the dough stripping elements 29, 99, 110, 129, or 229. Valves (not shown) can be placed at any position along the lines 248. Vibrator 170 can be directly connected to the stripping elements 29, 99, 110, 129, or 229. Alternatively, the vibration means can include connection lines 180 connecting the vibrator 170 to the stripping elements 29, 99, 110, 129, or 229 at connections 190. Alternatively, the compressed air 138 and/or vibration means can be connected to the stripping assembly 10 or the dough sheeting machine 14 in spaced relation relative to stripping elements 29, 99, 110, 129, and 229.

FIG. 4A best illustrates an overview of the method of the instant invention. The method is characterized as a method for selectively removing portions of sheeted dough and includes a preliminary step of sheeting the dough by a pair of rollers including a front roller 18 and a back roller 19 between which is provided a pinch point 17 for sheeting the dough. Sheeted dough 20 is then shaped or cut by die roller 78 in another preliminary step. The dough remains adhered to the front roller and moves counterclockwise, (as indicated by arrow 115), up the front roller 18 to a point where shaped dough 16 is removed by the stripping element 29. The shaped dough 16 is then carried away by a conveyer to be further processed into a food product. The remaining dough, which is not removed by the stripping element 29, continues to be at least partially adhered to the front roller. This adhered dough is carried as the web or rework 25 back around to a mass of dough 27 to be recycled and reentered into the sheeting and cutting steps of the process.

The web or rework 25 is comprised of two portions. A first portion 118 as shown in FIG. 3 is permitted to pass over crosspiece 30 while a second portion 121 remains adhered to the outer surface 39 of the front roller. In this way, the second portion 121 carries the first portion 118 along with it to return the first portion of the web or rework 25 to the mass of dough 27 for reentry into the sheeting and cutting process.

As can be appreciated from the description above, the method includes selectively positioning the scraper elements 29 at a circumferential position on the surface of the front roller 18. Positioning the scraper elements 29 can be achieved at least in part by means of the adjustment mechanisms 58 of the brackets 50 that support the mounting bar 38. Additionally, at least one support means 61 are optionally implemented for adjusting and supporting the stripping elements 29, 99, 110, 129, or 229 in the fore and aft direction on the dough sheeting machine. The screws of support means can be adjusted in order to selectively adjust the amount of pressure with which the stripping elements 29, 99, 110, 129, or 229 contact the front roller 18.

The act of positioning the stripping elements 29 entails considering the consistency of the dough 20. Some doughs have more gluten and are therefore more elastic in their consistency than others. The more elastic doughs are stronger under tensile stress and therefore hold together better. Another factor that affects dough consistency is the moisture content of the dough. Doughs that are dry may be crumbly and non-elastic, while doughs that are wet tend to be more sticky. On the other hand, some wet doughs tend to sag and may be fragile and non-elastic.

Thus, the position of the stripping elements is selected to accommodate the characteristics of the particular dough being sheeted and shaped. For example, for more dry or fragile doughs, the stripping elements may be positioned to abut the front roller at a position in the range from 2:30 to 6:00 o'clock in scraping relation when viewed along an axis of the roller as it turns in a counterclockwise direction 115. For elastic or glutinous doughs, a position in the larger range from 2:00 to 7:00 o'clock can be selected.

The position at which the stripping element is made to abut the front roller is selected to properly balance the forces acting on the dough so that the adhesion and inertia acting on the web or rework 25 is sufficient to overcome any separating force applied to portions 118 thereof by the stripping elements 29, 99, 110, 129, or 229 and by gravity. Likewise, the forces applied to the shaped dough 16 by the stripping elements 29, 99, 110, 129, or 229 and gravity must work together to properly lay the shaped dough 16 on a conveyor belt 15 of the dough sheeting machine 14. The forces of the stripping elements 29, 99, 110, 129, or 229 and gravity on the shaped dough must be balanced with the force of inertia of the shaped dough 16 so that the shaped dough does not crumple or otherwise become damaged. Of course, the speed of the rollers and conveyor belt 15 as well as the position of the conveyor belt 15 may need to be adjusted as well. In most cases, the position at which the stripping elements 29, 99, 110, 129, or 229 should abut the front roller 18 is approximately from 3:00 to 4:00 o'clock when viewed along the axis 65 of the front roller 18 with the roller 18 moving in a counterclockwise direction.

There are many other variations of the above described apparatuses and method that are within the spirit and scope of this invention. Therefore, the invention is to be limited only by the claims that follow.

We claim:

1. A gapped dough stripping assembly for a dough sheeting machine, said assembly for stripping shaped dough from a front roller after a pattern has been cut in a sheet of dough in said machine and for leaving a web of dough on said front roller for reworking, said assembly comprising:
at least one crosspiece having an edge adapted for parallel alignment with a front roller on which dough regularly sticks;
at least one spacer leg supporting said crosspiece and extending transversely from said crosspiece;
at least one mounting bar supporting said spacer leg and extending transversely to said spacer leg;
wherein said mounting bar is adapted to be mounted to said dough sheeting machine to support said at least one spacer leg and said crosspiece in a position with said crosspiece substantially abutting said front roller to scrape shaped dough from said front roller and leave said rework at least partially adhered to said front roller so that said shaped dough is removed for further processing while said rework moves with an outer surface of said front roller and is returned and joined to a mass of dough upstream of a pinch point to be re-entered in a sheeting step.

2. The assembly of claim 1, wherein said crosspiece is a first crosspiece of a plurality of crosspieces, said spacer leg is a first spacer leg of a plurality of spacer legs, and each of said spacer legs supports at least one of said plurality of crosspieces.

3. The assembly of claim 2, wherein said mounting bar supports said plurality of said spacer legs.

4. The assembly of claim 3, wherein said plurality of spacer legs are supported on said mounting bar in spaced relation to each other and support said crosspieces in spaced relation such that there is at least one gap between longitudinal ends of adjacent ones of said crosspieces.

5. The assembly of claim 4, wherein said at least one gap is a first gap of a plurality of gaps formed between adjacent ones of said plurality of crosspieces.

6. The assembly of claim 2, wherein said spacer legs are removably supported on said mounting bar.

7. The assembly of claim 2, wherein said crosspieces are removably supported on said spacer legs.

8. The assembly of claim 1, further including:
at least one bracket for supporting said mounting bar and at least one fastener for attaching said bracket and said mounting bar to said dough sheeting machine; and
at least one adjustment means for adjustably positioning said mounting bar on said dough sheeting machine.

9. The assembly of claim 1, wherein at least a portion of said assembly is formed of an ultra high molecular weight material.

10. A dough sheeting machine having a dough stripping assembly for removing a shaped dough and leaving a web of dough for re-entry into a mass of dough upstream of a pinch point, said sheeting machine comprising:
a front roller to which dough generally sticks after being sheeted and cut, wherein sheeting and cutting produces said shaped dough and said web for return and re-entry in the sheeting and cutting process;
at least one stripping element supported on said sheeting machine and having a straight edge substantially abutting said front roller for scraping said shaped dough from said front roller while leaving said web at least partially adhered to said front roller for return to said mass of dough upstream of said pinch point.

11. The dough sheeting machine of claim 10, wherein:
said sheeting maching further comprising a mounting bar;
said stripping element comprises a spacer leg connected to a crosspiece;
said spacer leg is supported on the mounting bar; and
said spacer leg and said crosspiece generally form a T-shape.

12. The dough sheeting machine of claim 10, further comprising:
a die roller for cutting a predetermined pattern into said sheeted dough; and
said at least one stripping element having a straight edge with a width generally equal to a width of said predetermined pattern and said shaped dough such that said straight edge separates said shaped dough from said front roller while leaving at least a portion of said web adhered to said front roller.

13. The dough sheeting machine of claim 12, wherein:
said at least one stripping element is one of a plurality of stripping elements, and said straight edge is one of a plurality of straight edges on respective stripping elements of said plurality of stripping elements, and
said plurality of stripping elements have gaps between longitudinal ends of adjacent ones of said straight edges; and
a distance between said longitudinal ends is generally equal to a distance between adjacent rows of said shaped dough such that at least a portion of said web between said shaped dough is left adhered to said front roller after scraping by said straight edges.

14. The dough sheeting machine of claim 10, wherein said straight edge abuts the front roller between a 7 o'clock and a 2 o'clock position on an outer surface of said front roller when viewed along an axis of rotation with the front roller rotating in a counter-clockwise direction.

15. The dough sheeting machine of claim 14, wherein said straight edge abuts the front roller at approximately a 4 o'clock position.

16. A method of removing shaped dough from a front roller of a dough sheeting machine by a stripping assembly having a rigid stripping element mounted to a mounting bar, the method comprising the steps of:
positioning said rigid stripping element in abutting scraping relation to a front roller;
separating said shaped dough from said front roller by said stripping element; and
leaving a web of dough adhered to unscraped portions of said front roller.

17. The method of claim 16, wherein said stripping element is a first stripping element of a plurality of stripping elements, and said shaped dough is a first row of a plurality of rows of shaped dough, said method further comprising the steps of:
spacing said plurality of stripping elements from each other such that a gap is provided between respective ends of adjacent ones of said stripping elements;
in said step of leaving, leaving a web of minimum width between adjacent ones of said plurality of rows;
providing said stripping elements with widths generally equal to maximum widths of said rows of shaped dough; and
positioning said plurality of stripping elements in alignment with said plurality of rows such that said gaps are correlated with said minimum width of said web so that a portion of said web remains unscraped during the step of separating.

18. The method of claim 16, wherein said stripping element comprises a crosspiece having said straight edge for scraping and a spacer leg supporting said crosspiece on said mounting bar, and wherein the step of leaving further comprises:
separating a first portion of said web of dough from said front roller by said crosspiece of said stripping element;
permitting said first portion of a web to pass over the crosspiece while a second portion of said web remains adhered to said front roller; and
carrying said web of dough by said adhered second portion on said front roller back to a mass of dough upstream of a pinch point to be re-entered in a sheeting and a cutting step.

19. The method of claim 16, wherein said step of positioning further comprises positioning said stripping element such that it abuts the front roller between a 7 o'clock and a 2 o'clock position on an outer surface of said front roller when viewed along an axis of rotation with the front roller rotating in a counter-clockwise direction.

20. The method of claim 19, wherein said step of positioning still further comprises positioning said stripping element such that it abuts the front roller at approximately a 4 o'clock position.

21. A dough stripping assembly for a tortilla dough sheeting machine, said assembly for stripping shaped dough from a front roller after a pattern has been cut in a sheet of dough in said machine and for leaving a web of dough on said front roller for reworking, said assembly comprising:
at least one stripping element having a rigid edge adapted for parallel alignment with a front roller on which dough regularly sticks;
at least one mounting bar supporting said stripping element and adapted to be mounted on the dough sheeting machine; and
wherein said mounting bar is adapted to be mounted to said dough sheeting machine to support said at least one stripping element in substantially abutting position relative to said front roller to scrape shaped dough from said front roller and leave said rework at least partially adhered to said front roller so that said shaped dough is removed for further processing while said rework moves with an outer surface of said front roller and is returned and joined to a mass of dough upstream of a pinch point to be re-entered in a sheeting step.

22. The dough stripping assembly of claim 21, wherein said edge is supported on said mounting bar such that it will abut the front roller between a 7 o'clock and a 2 o'clock position on an outer surface of said front roller when mounted on said dough sheeting machine and viewed along an axis of rotation with the front roller rotating in a counter-clockwise direction.

23. The dough stripping assembly of claim 22, wherein said straight edge is supported on said mounting bar such that it will abut the front roller at approximately a 4 o'clock position.

24. The dough stripping assembly of claim 21, wherein said stripping element is a first stripping element of a plurality of stripping elements, said plurality of stripping elements are supported on said mounting bar in spaced relation to each other such that there is at least one gap between ends of adjacent ones of said stripping elements.

25. The dough stripping assembly of claim 24, wherein said at least one gap is a first gap of a plurality of gaps formed between adjacent ones of said plurality of stripping elements.

28. The dough stripping assembly of claim 21, further including:
at least one bracket for supporting said mounting bar and at least one fastener for attaching said bracket and said mounting bar to said dough sheeting machine; and
at least one adjustment means for adjustably positioning said mounting bar on said dough sheeting machine.
